(19) United States
(12) Patent Application Publication
(10) Pub. No.: US 2018/0109904 A1
(43) Pub. Date: Apr. 19, 2018

(54) DUAL NETWORK METHOD OF SENDING APPLICATION

(71) Applicant: DMITRY KRUGLOV, NEW PALTZ, NY (US)

(72) Inventor: DMITRY KRUGLOV, NEW PALTZ, NY (US)

(21) Appl. No.: 15/294,214

(22) Filed: Oct. 14, 2016

(51) Int. Cl. H04W 4/00; H04M 7/00; H04W 36/12

(52) U.S. Cl. CPC H04W 4/003; H04W 88/06; H04W 36/12; H04M 7/006

(57) ABSTRACT

The present invention relates to a method of transmitting transactional data using software (APP) installed on a device capable of wirelessly accessing both the INTERNET (Data Network) and Voice Network (a.k.a. SMARTPHONE) from a user/client device to a system/Service Provider continuously, without prompt-response for each transactional parameter.

### BACKGROUND OF THE INVENTION

### 1. Field of the Invention: Data Transmission Method

Most of “on-line” electronic transactions use either the Internet browser based graphical user interface forms or Dual-Tone Multi-Frequency Signaling (DTMF) (a.k.a touch tone) telephone capability to enter and communicate transactional information to the service [provider]. A transaction may be instructions to make a purchase, or receive information update, or communicate information update request.

### 2.1 Connection Methods

2.1.1 The Corded phones gace user audible dialtone to indicate that there is a connection with a telephone exchange and that they can begin dialing. Users dialed each digit transmitting one by one while staying connected to the telephone exchange.

2.1.2 Wireless phones and smartphones use “store-then-send” method to save network time usage. There is no dialtone in cordless phones because they do not need to be connected to network to [let user] begin dialing. A phone number is entered and stored in the phone's memory first and when user pushes “call” button, phone initiates network connection and transmits the number in its entirety.

### 3. Entry Methods

3.1 Interactive Touch-tone and Interactive Voice Response Systems (IVR) for WIRED PHONES

Interactive Touch-tone/Voice Response automated phone systems were introduced as soon as DTMF capable phones became widely available. Such automated phone systems rely on prompt-response format of message entry. To use such system a user must initiate a connection and then enter information piece by piece while staying connected.

Users enter information (including menu selections) by pressing phone buttons in their phones to generate DTMF signals to navigate menu selections and obtain information or perform transactions. Alternatively they can user pre-defined voice commands to communicate same information.

3.1.2 DTMF and IVR for WIRELESS PHONES and SMARTPHONES

Interactive Touch-tone/Voice response automated phone systems were originally designated for wired phones and they work in the same way whether accessed by wired [phones] or wireless smartphones.

3.2 INTERNET [Native] Applications for wireless devices (APPs) and Graphical user interface Data Entry Form (GUI) for SMARTPHONES

3.2.1 A SMARTPHONE user can connect wirelessly to the Internet, access GUI, enter information, and send transactional request, all while staying connected.

The information entered in a GUI is transmitted using one of the Internet protocols. It is a very common method, like one used to complete applications on USPTO.GOV website.

There is no need to describe inner working of this process as it is a common knowledge and is not subject of any claim within this application.

3.2.2 Another way a SMARTPHONE can send transactional request, is by using GUI in an APP. APPs on wireless devices do not need active internet connection to enter the information into a GUI: Transactional request information is entered and stored in the phone's memory first, and when user pushes appropriate button, such as or, phone initiates network connection and transmits the message in its entirety

The main difference between 3.2.1 and 3.2.2 is similar to that of wired and wireless phones in 2.1.1 and 2.1.2 above: Users must first initiate and maintain connection to the INTERNET while entering information into the INTERNET based GUI, while APPs use “store-then-send” method.

### 4. Networks-Voice and Data

SMARTPHONES are capable of wirelessly accessing both the INTERNET (Data Network) and voice networks, also known as Public Switched Telephone Network (PSTN).

4.1 Interactive Touch-tone/Voice response automated phone systems are accessed via voice network by dialing a predefined phone number.

4.2 APPs transmit data over the INTERNET (Data Network) by sending it to a predefined network address

### 5. Problems this Invention Aims to Solve

For service APP providers, it is cheaper to use data networks. However, there are times when it does not work for APP users.

5.1 Worldwide, Voice and data network coverage varies greatly, and depending on location and communications carrier, one of the networks (voice or data) may communications carrier, one of the networks (voice or data) may be cheaper to use, or more reliable, or both.

5.2 The use of wireless INTERNET to access GUIs referenced in 3.2.1 occasionally results in data transmission failure. A common cause of such failure is some physical barrier, like a wall, between the user and the internet access point that degrades quality of signal so that the message cannot reach the internet access point, and the entire transaction fails.

5.3 Other cause may be too great distance between user and receiving antenna, resulting in the same signal degrading effect as from physical barriers.

5.4 Often times transaction fails due to service provider's own network or host computer problems.

5.5 Finally, a user may have reached his or her monthly wireless data usage limit allocated by a provider and may be unable to complete transaction for that reason.

### 6. SUMMARY OF THE INVENTION

A method to bypass problems in 5.1-5.5 and deliver the information to the service provider, using a for a SMARTPHONE APP and an Interactive Touch-tone/Voice response automated phone system optimized for use with such APP.

Where APP can control dialing and data access functionality, and utilizes both voice and data networks, and repeatedly attempts to re-deliver message if the first attempt fails using a different network or using different INTERNET IP address or phone number on the same network. The APP will use a logical switch to selects which network to use, based on a manual user input or automatically, based on predefined criteria For the first and all subsequent message delivery attempts.

Where Interactive Touch-tone/Voice response automated phone system can accept message in a prompt-response entry format or an unprompted and uninterrupted audio string (Over regular phone lines, DTMF is sent as audio). To accommodate an unprompted and uninterrupted entry, the system may delay playing prompts and wait for incoming message for a period of time predefined by system designer, or stop playing prompts for as long as it is receiving valid information entries.

To take as an example a bank money transfer from savings to checking account. For the purpose of this example, sender initial authentication and sender's act of confirming a transaction are omitted here, as they may or may not be required to complete transmission of transactional data.

Step 1: An APP would present a user with a GUI asking to select action type, and user selects “transfer between accounts”

Such action requires, at minimum, following information

Step 2: Select Source Account

Step 3: Select Destination Account

Step 4: Enter Transfer Amount

Step 5: Enter Effective transfer date

(Optional) Step 6: Send via Internet/Send via Phone

So, the information collected in those 5 steps is then stored in the SMARTPHONE's memory and then APP would attempt to sent this transaction request to the bank.

If user knows that there is no more data left in monthly calling plan, in step 6 it could chose “Send via Phone”

Let's assume that APP is preprogrammed to send via the INTERNET first, and via Phone (Voice Network) second.

Upon receiving transactional input from the user in steps 1-5 above, APP will store that information in SMARTPHONE's memory and attempt to transmit the information via the INTERNET to a predefined INTERNET IP address. Let's further assume that the Internet service provider for the bank is having network problems and transaction fails. Upon failing to receive transaction confirmation, APP would retrieve stored message from SMARTPHONE's memory, re-encode it as an audio message string (Over Voice Networks, DTMF is sent as audio), dial predefined phone number to access bank's Interactive Touch-tone/Voice response automated phone system, and upon connecting a call transmit uninterrupted audio string.

The Interactive Touch-tone/Voice response automated phone system will accept a string and process the transaction or, if the volume of concurrent connections exceeds its processing capacity, switch incoming call to a audio recording system or other network attached device capable of recording and temporary storing uninterrupted audio message string, and then to retrieving and processing stored message when system processing capacity becomes available again. cm I. A method and a system for optimizing Interactive Touch-tone/Voice response automated phone systems for both SMARTPHONE and human access, consisting of an Interactive Touch-tone/Voice response automated phone system

I.I.I. Where Interactive Touch-tone/Voice response automated phone system, upon receiving a call, operates under assumption that the connection is initiated by a SMARTPHONE APP, and upon establishing a connection, delays playing greetings or prompts and waits for a period of time, defined by system owner, to receive uninterrupted audio message string (Over regular phone lines, DTMF is sent as audio).

I.I.II. Where Interactive Touch-tone/Voice response automated phone system, upon receiving a call, can receive and process or store uninterrupted audio message string (Over regular phone lines, DTMF is sent as audio) regardless whether it is playing greetings or prompts.

I.I.III. Where Interactive Touch-tone/Voice response automated phone system, during high call volume periods, can send calls initiated by a SMARTPHONE APP to voice mail or other network attached device capable of recording and temporary storing uninterrupted audio message string, and then to retrieving and processing stored message when system processing capacity becomes available again.

I.II. A system in I.I.I, which will switch to operate in traditional Interactive Touch-tone/Voice response Prompted input mode if, by the end of the time period defined by the system owner, no input is received, or received input is invalid.

I.II.I. An Interactive Touch-tone/Voice response automated phone system which uses signal encoder that operates at slow or medium speed so that would be compatible with human users and A SMARTPHONE APP in I.IX

I.III. A SMARTPHONE APP that contains, or has access, to predefined phone number(s) and predefined network addresses, and is capable of controlling the telephone dialing function and accessing Interactive Touch-tone/Voice response automated phone system over voice networks and capable of accessing data networks from a Smartphone.

I.IV. A SMARTPHONE APP in I.III where a selection can made whether to use voice or data network for transmission. A selection may specify that only one network should be used, or both—first one, and then another if prior transmission attempt failed.
There may be numerous embodiments of methods to make such selection, which may include a pop-up dialog box asking user to manually select network before or after data entry, or from APP Settings menu, or “hard-coded” selection by an APP maker that is not user accessible

I.V. A SMARTPHONE APP in I.III where information entered in a GUI is stored in SMARTPHONE's memory and is available for transmission both via voice and data network, so that if the first transmission attempt fails, it is available for resending via another available network without the need to re-enter information.

I.VI. A SMARTPHONE APP in I.III where APP is accessing phone's settings to check wireless signal strength and automatically switching to PSTN when wireless INTERNET signal strength is below specified level

I.VII. A SMARTPHONE APP in I.III where APP is directing SMARTPHONE to check remaining data balance with cellular services provider and is automatically switching to PSTN when remaining data balance is below specified level

I.VIII. A SMARTPHONE APP in I.III where upon failing to transmit a message over a chosen network will automatically attempt to retransmit same stored message over the same network but to a different predefined phone number or Internet IP address predefined number of times before before trying to send same stored message over another network.

I.IX. A SMARTPHONE APP in I.III which uses signal encoder that operates at slow or medium speed so that would be compatible with Interactive Touch-tone/Voice response automated phone system designed for human user input. By way of example, standard Motorola rate encoder sends 2 digits per second, where as “Whelen” sends 16 digits per second. High speed encoders send 25+digits per second
